(19) United States
(12) Patent Application Publication
(10) Pub. No.: US 2019/0229490 A1
(43) Pub. Date: Jul. 25, 2019

(54) VOLTAGE-CONTROLLABLE LASER OUTPUT COUPLER FOR INTEGRATED PHOTONIC DEVICES

(71) Applicants: MACQUARIE UNIVERSITY, New South Wales (AU); NEWSOUTH INNOVATIONS PTY LIMITED, New South Wales (AU)

(72) Inventors: Alex Fuerbach, New South Wales (AU); Christoph Wieschendorf, New South Wales (AU); Francois Ladouceur, New South Wales (AU); Leonardo Silvestri, New South Wales (AU)

(73) Assignees: MACQUARIE UNIVERSITY, New South Wales (AU); NEWSOUTH INNOVATIONS PTY LIMITED, New South Wales (AU)

(21) Appl. No.: 16/308,085

(22) PCT Filed: Jun. 8, 2017
(86) PCT No.: PCT/AU2017/050574

§ 371 Date: Dec. 7, 2018

(30) Foreign Application Priority Data
Jun. 9, 2016 (AU) 2016902248

(51) Int. Cl. H01S 3/115; C09K 11/77; H01S 3/11; H01S 3/106; G02F 1/141; H01S 3/067; H01S 3/17; H01S 3/16; H01S 3/08; H01S 3/10; H01S 3/105

(52) U.S. Cl. CPC H01S 3/115; C09K 11/7774; H01S 3/1103; H01S 3/1065; G02F 1/141; G02F 2001/1414; H01S 3/173; H01S 3/1618; H01S 3/08054; H01S 3/10061; H01S 3/105; H01S 3/06733

(57) ABSTRACT

A voltage-controllable output coupler for a laser, comprising: a liquid crystal cell that provides a change in birefringence in response to an applied voltage; and a polariser oriented with respect to the liquid crystal cell to collectively form a variable reflectance mirror for the laser; wherein output coupling of the laser is controllable by applying voltage to the liquid crystal cell for a switching interval to switch the variable reflectance mirror from high reflectance to low reflectance, and vice versa, thus actively Q-switching or cavity dumping the laser.

### FIELD

The present invention relates to a voltage-controllable laser output coupler for integrated photonic devices.

### BACKGROUND

Integrated photonic devices (or integrated photonic circuits) are optical systems that are miniaturized and fabricated within transparent dielectric materials to generate, transmit and/or process optical signals with reduced size and power. Integrated photonic devices have a vast array of potential commercial applications, including light detection and ranging (LIDAR), lab-on-chip (LOC) medical diagnostics, environmental sensing, free space optical (FSO) communication, direct infrared countermeasures (DIRCM), etc.

In particular, waveguide lasers (or glass chip lasers) have recently attracted a great deal of interest, since their compact size, inherent robustness and high peak-power handling capabilities make them perfectly suited for pulsed Q-switched or cavity-dumped operation at nanosecond timescales in a vast range of integrated photonic devices.

A key challenge that must be resolved before integrated waveguide lasers reach their full potential in broad-based commercialisation is the development of compact, fast and actively controllable output couplers (or modulators) that enable integrated waveguide lasers to be actively Q-switched and/or cavity dumped, thus generating optical pulses on nanosecond timescales. Existing acousto-optic or electro-optic modulators (eg, Pockels cells) are bulky, often need active cooling and require either Radio-Frequency voltage (RF) or High Voltage (HV) power supplies, and are thus not suitable for use in integrated waveguide lasers.

A need therefore exists for alternative actively controllable output couplers that are more suited for use with integrated waveguide lasers.

### SUMMARY

According to the present invention, there is provided a voltage-controllable output coupler for a laser, comprising:

a liquid crystal cell that provides a change in birefringence in response to an applied voltage; and

a polariser oriented with respect to the liquid crystal cell to collectively form a variable reflectance mirror for the laser;

wherein output coupling of the laser is controllable by applying voltage to the liquid crystal cell for a switching interval to switch the variable reflectance mirror from high reflectance to low reflectance, and vice versa, thus actively Q-switching or cavity dumping the laser.

The applied voltage may be less than around 100 V, for example, between around 5 V and around 80 V, such as around 50 V.

The switching interval may be less than around 5 microseconds resulting in an optical pulse width less than around 100 nanoseconds, for example, less than around 50 nanoseconds.

The voltage may be applied in pulses of the switching interval having a repetition rate from around 0.1 kHz to greater than around 50 kHz.

The liquid crystal cell may comprise deformed helix ferroelectric (DHF) liquid crystals between front and back glass substrates that are coated to act as electrodes, and wherein the back glass substrate also acts as a mirror. The mirror may comprise a metallic layer, a Bragg reflector, a prism, and combinations thereof.

The polariser may comprise a glass polariser, a thin film polariser, a polarising beam splitter, a polarisation mode selective waveguide, a wire-grid polariser, and combinations thereof.

The laser may comprise a depressed-cladding waveguide laser, for example, an optically pumped rare-earth doped ZBLAN (ZrF₄, BaF₂, LaF₃, AlF₃, NaF) depressed-cladding chip laser.

The liquid crystal cell, the polariser and the waveguide laser may be integrated together on a substrate to form an integrated photonic device.

Alternatively, the laser may comprise a fiber laser, for example, an optically pumped rare-earth doped fiber laser.

The present invention also provides an integrated photonics device comprising a waveguide laser and the voltage-controllable output coupler described above.

The integrated photonic device may comprise a LIDAR device, a LOC medical diagnostic device, a sensor, a FSO communication device, a DIRCM device, and combinations thereof.

The present invention further provides a method, comprising:

providing a liquid crystal cell that provides a change in birefringence in response to an applied voltage;

orienting a polarizer with respect to the liquid crystal cell to collectively form a variable reflectance mirror for the laser;

controlling output coupling of the laser by applying voltage to the liquid crystal cell for a switching interval to switch the variable reflectance mirror from high reflectance to low reflectance, and vice versa, thus actively Q-switching or cavity dumping the laser.

The method may further comprise optimising an output coupling ratio for the laser by varying the switching interval of the variable reflectance mirror, varying composition of the liquid crystal cell, varying thickness of the liquid crystal cell, varying orientation of the polariser and the liquid crystal cell, varying voltage applied to the liquid crystal cell, and combinations thereof.

The method may further comprise optimising the optical pulse width by varying the switching interval of the variable reflectance mirror, varying composition of the liquid crystal cell, varying thickness of the liquid crystal cell, varying orientation of the polariser and the liquid crystal cell, varying voltage applied to the liquid crystal cell, and combinations thereof.

### BRIEF DESCRIPTION OF DRAWINGS

Embodiments of the invention will now be described by way of example only with reference to the accompanying drawings, in which:

FIGS. 1 and 2 are schematic diagrams of voltage-controllable output couplers for waveguide lasers according to embodiments of the present invention;

FIG. 3 is a schematic diagram of a voltage-controllable output coupler for a fiber laser according to another embodiment of the invention;

FIGS. 4 to 7 are graphs of experimentally obtained laser Q-switching performance using the voltage-controllable output coupler of embodiments of the invention; and

FIG. 8 is a schematic diagram of a proof-of-principle example of the voltage-controllable output coupler using bulk optical components.

### DESCRIPTION OF EMBODIMENTS

Referring to the drawings, a voltage-controllable output coupler 18 for a laser cavity 12 according to an embodiment of the present invention may generally comprise a liquid crystal cell 16 and a polariser 14. The liquid crystal cell 16 may change its birefringence in response to applied voltage from a controllable voltage source (not shown) to induce a variable polarisation change of an incident optical field. The polariser 14 may be optically oriented with the liquid crystal cell 16 so that they collectively form a variable reflectance mirror for the laser cavity 12.

In use, output coupling of the laser cavity 12 may be actively controlled by applying voltage to the liquid crystal cell 16 for a switching interval to switch the variable reflectance mirror from high reflectance to low reflectance, and vice versa, thus actively Q-switching and/or cavity dumping the laser cavity 12.

For a given laser cavity 12, an output coupling ratio (or output coupling coefficient or factor), and hence switching performance, may be optimised by varying composition of the liquid crystal cell 16, varying thickness of the liquid crystal cell 16, varying orientation of the polariser 14 and the liquid crystal cell 16, varying voltage applied to the liquid crystal cell 16, and combinations thereof. For example, the output coupling ratio may be optimised by varying the thickness of the liquid crystal cell 16 to provide a phase change in propagation of π or a multiple thereof.

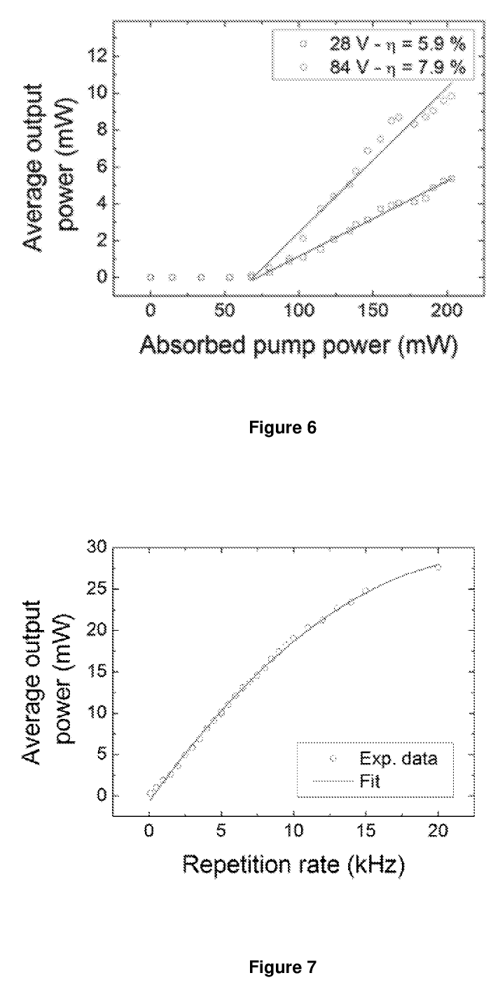

For a given laser cavity 12, the switching interval, and hence switching performance, of the variable reflectance mirror (or the response time of the liquid crystal cell 16), may also be optimised by varying composition of the liquid crystal cell 16, varying thickness of the liquid crystal cell 16, varying orientation of the polariser 14 and the liquid crystal cell 16, varying voltage applied to the liquid crystal cell 16, and combinations thereof. FIG. 4 is a graph of experimentally obtained laser Q-switching performance in terms of modulation depth and switching speed based on increasing applied voltage to the liquid crystal cell 16. It may be seen from FIG. 4 that a higher applied voltage may generally result in a higher output coupling efficiency. The applied voltage may therefore be selectively varied depending on the output coupling efficiency, or coupling factor, that is required.

The voltage applied to the liquid crystal cell 16 may, for example, be less than around 100 V, for example, between around 5 V and around 80 V, such as around 50 V. The switching interval and the accompanied birefringence-modulation of the liquid crystal cell 16 may, for example, be less than around 5 μs in duration resulting in an optical pulse width less than around 100 nanoseconds, for example, less than around 50 nanoseconds. The voltage may be applied to the liquid crystal cell 16 in pulses of the switching interval having a repetition rate that is tunable, for example, from around 0.1 kHz to greater than around 50 kHz.

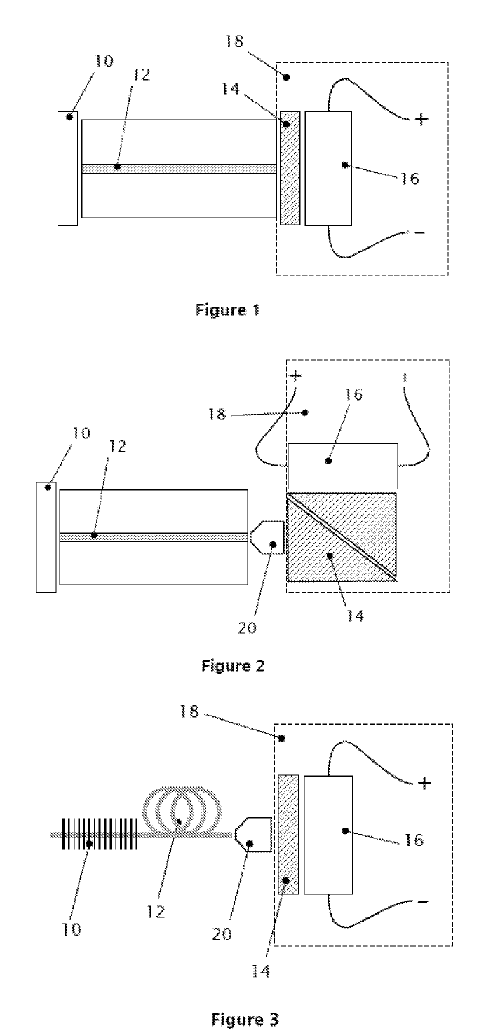

The polariser 14 may comprise a glass polariser, a thin film polariser, a polarising beam splitter, a polarisation mode selective waveguide, a wire-grid polariser, and combinations thereof. For example, FIGS. 1 and 2 illustrate embodiments where the polariser 14 may comprise a thin film or glass polariser and a polarising beam splitter, respectively. The polarising beam splitter 14 in FIG. 2 may be optically coupled to the waveguide laser cavity 12 by a GRIN lens 20.

The liquid crystal cell 16 may comprise DHF liquid crystals between front and back glass substrates that are coated to act as electrodes (eg, Indium tin oxide (ITO)), and wherein the back glass substrate also acts as a mirror. The back glass substrate may be coated with a silver/gold layer that provides the reflectivity for the signal light. The front and back glass substrates may be coated by ITO which is the (optically transparent) electrode material. ITO is not a metal but a ceramic or alloy. The gold/silver may be deposited in addition to, or could replace, one of the two ITO electrodes, but one of the electrodes must be transparent. A suitable DHF liquid crystal cell 16 is commercially available from Zedelef Pty Ltd and is described in US 2014/0354263, and Q Guo, Z Brozeli, E P Pozhidaev, F Fan, V G Chigrinov, H S Kwok, L Silvestri, F Ladouceur, Optics Letters Vol. 37, No. 12 (2012), which are hereby incorporated by reference in their entirety. It should be noted that liquid crystal cells have not previously been used in actively controllable laser output couplers for Q-switching and/or cavity dumping until now, due to their slow response time (typically larger than sub milliseconds for nematic liquid crystals). Furthermore, the documents described above proposed using DHF liquid crystals as passive transducers in sensing applications. It has now surprisingly been discovered by the present applicants that DHF liquid crystals may be alternatively used as actively controllable electro-optic modulators for Q-switching and/or cavity dumping of lasers.

The laser cavity 12 may comprise a depressed-cladding waveguide laser, for example, a rare-earth doped ZBLAN depressed-cladding chip laser. A suitable ZBLAN depressed-cladding chip laser 12 is described in U.S. Pat. No. 8,837,534, and G Palmer, S. Gross, A Fuerbach, D. Lancaster, M Withford, Opt. Express Vol. 21, 17413-17420 (2013), which are hereby incorporated by reference in their entirety.

Referring to FIGS. 1 and 2, the liquid crystal cell 16, the polariser 14 and the waveguide laser cavity 12 may be integrated together on a substrate, such as a glass or crystal chip, to form an integrated photonic device. The integrated waveguide laser cavity 12 may comprise an in-coupling dichroic mirror 10 enabling optical pumping of the laser cavity 12. The integrated photonic device may, for example, comprise a LIDAR device, a LOC medical diagnostic device, a sensor, a FSO communication device, a DIRCM device, and combinations thereof.

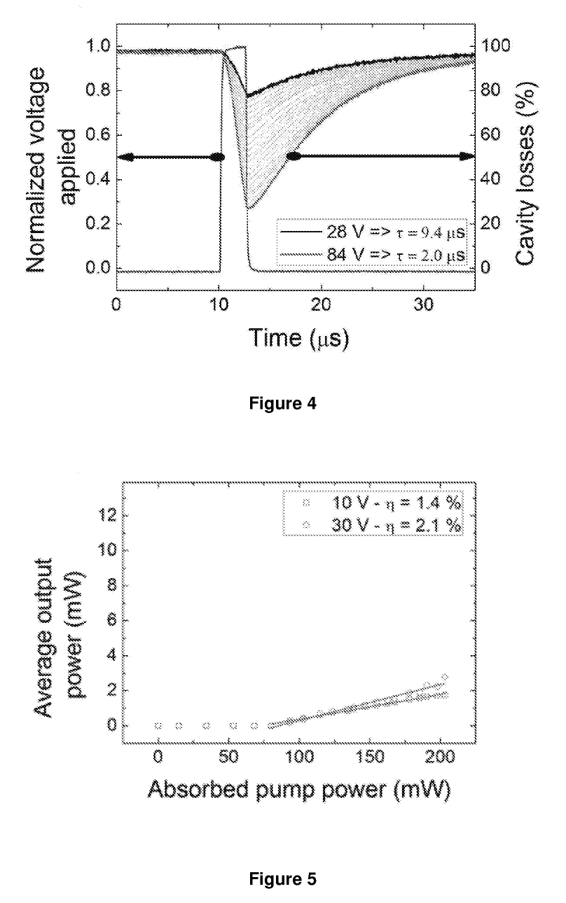

Although primarily intended for use within integrated waveguide laser cavities, embodiments of the present invention may alternatively be used with a fiber laser cavity, for example, using rare-earth doped fibers. FIG. 3 illustrates an example implementation of the invention using a fiber cavity 12 with a Bragg grating 10 used as the in-coupling mirror.

The invention will now be described in more detail, by way of illustration only, with respect to the following example. The example is intended to serve to illustrate this invention, and should not be construed as limiting the generality of the disclosure of the description throughout this specification.

### EXAMPLE

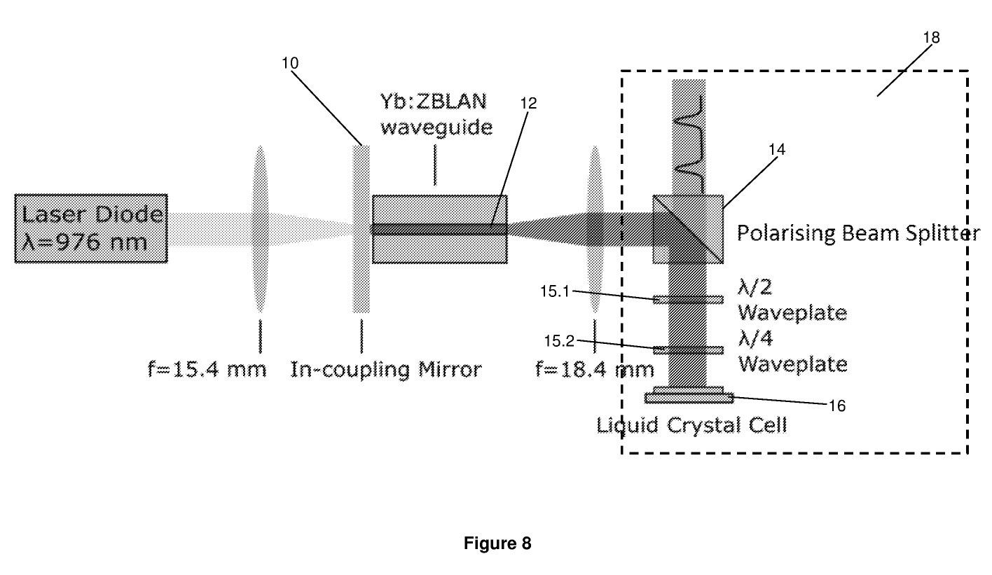

Proof-of-principle experiments were conducted using the bulk optical components illustrated in FIG. 8. The voltage-controllable output coupler 18 comprised a polarising beam splitter 14 combined with two waveplates 15.1, 15.2 followed by a DHF liquid crystal cell 16 (Zedelef). The laser 12 comprised a diode-pumped Ytterbium-doped ZBLAN depressed-cladding chip laser 12.

Initially, a DHF liquid crystal cell 16 having a thickness of 3.2 μm was used and driven by a low voltage of 10 V. In this proof-of-principle setup, the laser 12 exhibited a slope efficiency of 1.4% at a repetition rate of 5 kHz. As shown in FIG. 5, a slope efficiency of 2.1% was obtained using the 3.2 μm cell 16 when the applied voltage was increased to 30 V.

A 9.0 μm thick cell 16 was then selected and used with a voltage of 28V. This achieved a slope efficiency of 4.2% at a repetition rate of 5 kHz. As shown in FIG. 6, after increasing the voltage to 84V, a slope efficiency of 7.9% was achieved for the same repetition rate. FIG. 7 shows the average output power of the laser that was achieved, as a function of the repetition rate, using the 9.0 μm thick cell 16. The output power increased linearly with the repetition rate (corresponding to a constant energy per pulse) until starting to saturate above 10 kHz. The experiments, therefore, showed that slope efficiency increases at higher frequencies and becomes as high as 22% at 20 kHz with a frequency-independent laser threshold of 80 mW of absorbed pump power.

The slope efficiency and Q-switching performance obtained with bulk optical components in this example may be expected to be significantly improved when the optical components are optimised for a given laser system and integrated together.

Embodiments of the present invention provide active, voltage-controllable output couplers that are useful for active Q-switching or cavity dumping waveguide lasers or fiber lasers. Embodiments of the invention provide tunable modulator technology as an integrated Q-switch in a miniaturised waveguide chip laser architecture. This provides a new class of compact and robust short-pulsed and fully-integrated laser transducers. The transducers can be used to act as a fast, miniaturised and electronically controllable output coupler in the waveguide laser, and can thus be used to implement Q-switching and/or cavity dumping in those lasers. Moreover, the ability to actively control the degree of output coupling in the waveguide laser enables the possibility to maximise the output power at all pump power levels. Pulsed, miniaturised chip lasers can find numerous applications, in particular as the current invention is not limited to a certain laser gain material and can thus be implemented at all wavelengths from the visible to the mid-infrared. Compared to existing acousto-optic modulators and electro-optic modulators, actively controllable output couplers of embodiments of the invention have several noticeable advantages, such as low driving power, low driving voltage, fast switching speed, and an extremely compact size. The inherent advantages of the integrated chip-laser architecture mean that the technology will lead to systems with reduced size, weight and power (SWaP), and which are more efficient, more rugged and more robust compared to alternative approaches.

For the purpose of this specification, the word “comprising” means “including but not limited to,” and the word “comprises” has a corresponding meaning.

The above embodiments have been described by way of example only and modifications are possible within the scope of the claims that follow.

1. A voltage-controllable output coupler for a laser, comprising:
a liquid crystal cell that provides a change in birefringence in response to an applied voltage; and
a polariser oriented with respect to the liquid crystal cell to collectively form a variable reflectance mirror for the laser;
wherein output coupling of the laser is controllable by applying voltage to the liquid crystal cell for a switching interval to switch the variable reflectance mirror from high reflectance to low reflectance, and vice versa, thus actively Q-switching or cavity dumping the laser.

2. The voltage-controllable output coupler of claim 1, wherein the applied voltage is less than around 100 V.

3. The voltage-controllable output coupler of claim 2, wherein the applied voltage is between around 5 V and around 80 V.

4. The voltage-controllable output coupler of claim 2, wherein the applied voltage is around 50 V.

5. The voltage-controllable output coupler of claim 1, wherein the switching interval is less than around 5 microseconds resulting in an optical pulse width less than around 100 nanoseconds.

6. The voltage-controllable output coupler of claim 5, wherein the optical pulse width is less than around 50 nanoseconds.

7. The voltage-controllable output coupler of claim 1, wherein the voltage is applied in pulses of the switching interval having a repetition rate from around 0.1 kHz to greater than around 50 kHz.

8. The voltage-controllable output coupler of claim 1, wherein the liquid crystal cell comprises DHF liquid crystals between front and back glass substrates that are coated to act as electrodes, and wherein the back glass substrate also acts as a mirror.

9. The voltage-controllable output coupler of claim 8, wherein the mirror comprises a metallic layer, a Bragg reflector, a prism, and combinations thereof.

10. The voltage-controllable output coupler of claim 1, wherein the polariser comprises a glass polariser, a thin film polariser, a polarising beam splitter, a polarisation mode selective waveguide, a wire-grid polariser, and combinations thereof.

11. The voltage-controllable output coupler of claim 1, wherein the laser comprises a depressed-cladding waveguide laser.

12. The voltage-controllable output coupler of claim 11, wherein the depressed-cladding waveguide laser comprises a rare-earth doped ZBLAN depressed-cladding chip laser.

13. The voltage-controllable output coupler of claim 1, wherein the liquid crystal cell, the polariser and the waveguide laser are integrated together on a substrate to form an integrated photonic device.

14. The voltage-controllable output coupler of claim 1, wherein the laser comprises a fiber laser.

15. The voltage-controllable output coupler of claim 14, wherein the fiber laser comprises a rare-earth doped fiber laser.

16. An integrated photonics device comprising a waveguide laser and the voltage-controllable output coupler of claim 1.

17. The integrated photonic device of claim 16, wherein the integrated photonic device comprises a LIDAR device, a LOC medical diagnostic device, a sensor, a FSO communication device, a DIRCM device, and combinations thereof.

18. A method, comprising:
providing a liquid crystal cell that provides a change in birefringence in response to an applied voltage;
orienting a polarizer with respect to the liquid crystal cell to collectively form a variable reflectance mirror for the laser;
controlling output coupling of the laser by applying voltage to the liquid crystal cell for a switching interval to switch the variable reflectance mirror from high reflectance to low reflectance, and vice versa, thus actively Q-switching or cavity dumping the laser.

19. The method of claim 18, further comprising optimising an output coupling ratio for the laser by varying the switching interval, composition of the liquid crystal cell, varying thickness of the liquid crystal cell, varying orientation of the polariser and the liquid crystal cell, varying voltage applied to the liquid crystal cell, and combinations thereof.

20. The method of claim 18, further comprising optimising the optical pulse width by varying the switching interval of the variable reflectance mirror, varying composition of the liquid crystal cell, varying thickness of the liquid crystal cell, varying orientation of the polariser and the liquid crystal cell, varying voltage applied to the liquid crystal cell, and combinations thereof.
